(19) United States
(12) Patent Application Publication
(10) Pub. No.: US 2025/0184062 A1
(43) Pub. Date: Jun. 5, 2025

(54) DYNAMICALLY CONFIGURING POSITIONING REFERENCE SIGNAL RESOURCES

(71) Applicant: QUALCOMM INCORPORATED, San Diego, CA (US)

(72) Inventors: Ahmed Attia Abotabl, San Diego, CA (US); Alexandros Manolakos, Athens (GR); Ahmed Elshafie, San Diego, CA (US); Muhammad Sayed Khairy Abdelghaffar, San Jose, CA (US); Hung Dinh Ly, San Diego, CA (US)

(21) Appl. No.: 18/843,663

(22) PCT Filed: Mar. 17, 2023
(86) PCT No.: PCT/US2023/064635

§ 371 Date: Sep. 3, 2024

(30) Foreign Application Priority Data
Apr. 15, 2022 (GR) 20220100327

(51) Int. Cl. H04L 5/00; H04W 64/00

(52) U.S. Cl. CPC H04L 5/0048; H04L 5/0094; H04W 64/00

(57) ABSTRACT

Methods, systems, and devices for wireless communication are described. A user equipment (UE) may receive an indication of a configuration for one or more positioning reference signal (PRS) resource sets that are each associated with one or more operating modes of a network entity. In some examples, the UE may also receive signaling that indicates a current operating mode of the network entity or an expiration timer for the one or more PRS resource sets. The UE may select a PRS resource set from the one or more PRS resource sets based on the current operating mode of the network entity, the expiration timer, or both. Accordingly, the UE may transmit a request to receive on-demand PRS transmissions via the selected PRS resource set. After transmitting the request, the UE may monitor the selected PRS resource set for the requested on-demand PRS transmissions.

### CROSS REFERENCE

The present application is a 371 national stage filing of International PCT Application No. PCT/US2023/064635 by Abotabl et al. entitled “DYNAMICALLY CONFIGURING POSITIONING REFERENCE SIGNAL RESOURCES,” filed Mar. 17, 2023; and claims priority to Greece Patent Application No. 20220100327 by Abotabl et al. entitled “DYNAMICALLY CONFIGURING POSITIONING REFERENCE SIGNAL RESOURCES,” filed Apr. 15, 2022, each of which is assigned to the assignee hereof, and each of which is expressly incorporated by reference in its entirety herein.

### FIELD OF TECHNOLOGY

The following relates to wireless communication, including dynamically configuring positioning reference signal (PRS) resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may determine positioning information by measuring positioning reference signals (PRS) from a network entity. In some cases, however, the UE may be unable to determine accurate positioning information if the network entity transmits the PRSs using different settings.

### SUMMARY

The described techniques relate to improved methods, systems, devices, and apparatuses that support dynamically configuring positioning reference signal (PRS) resources. For example, the described techniques provide for improving on-demand PRS transmission procedures between a user equipment (UE) and a network entity. In accordance with aspects of the present disclosure, a UE may receive an indication of a configuration for one or more PRS resource sets that are each associated with one or more operating modes of a network entity. In some examples, the UE may also receive signaling that indicates a current operating mode of the network entity or an expiration timer for the one or more PRS resource sets. The UE may select a PRS resource set from the one or more PRS resource sets based on the current operating mode of the network entity, the expiration timer, or both. Accordingly, the UE may transmit a request to receive on-demand PRS transmissions via the selected PRS resource set. After transmitting the request, the UE may monitor the selected PRS resource set for the requested on-demand PRS transmissions. The techniques described herein may improve the accuracy and reliability of on-demand PRS transmission procedures between the UE and the network entity.

A method for wireless communication at a UE is described. The method may include receiving a message that indicates a configuration of one or more reference signal resource sets each associated with one or more operating modes of a network entity, selecting a reference signal resource set from the one or more reference signal resource sets based on a current operating mode of the network entity, transmitting a request to receive reference signal transmissions via the selected reference signal resource set, and monitoring the selected reference signal resource set for the reference signal transmissions based on the request.

An apparatus for wireless communication is described. The apparatus may include a memory, a transceiver, and at least one processor of a UE, the at least one processor coupled with the memory and the transceiver. The at least one processor may be configured to cause the apparatus to receive, via the transceiver, a message that indicates a configuration of one or more reference signal resource sets each associated with one or more operating modes of a network entity, select a reference signal resource set from the one or more reference signal resource sets based on a current operating mode of the network entity, transmit, via the transceiver, a request to receive reference signal transmissions via the selected reference signal resource set, and monitor the selected reference signal resource set for the reference signal transmissions based on the request.

Another apparatus for wireless communication is described. The apparatus may include means for receiving a message that indicates a configuration of one or more reference signal resource sets each associated with one or more operating modes of a network entity, means for selecting a reference signal resource set from the one or more reference signal resource sets based on a current operating mode of the network entity, means for transmitting a request to receive reference signal transmissions via the selected reference signal resource set, and means for monitoring the selected reference signal resource set for the reference signal transmissions based on the request.

A non-transitory computer-readable medium storing code for wireless communication at a UE is described. The code may include instructions executable by a processor to receive a message that indicates a configuration of one or more reference signal resource sets each associated with one or more operating modes of a network entity, select a reference signal resource set from the one or more reference signal resource sets based on a current operating mode of the network entity, transmit a request to receive reference signal transmissions via the selected reference signal resource set, and monitor the selected reference signal resource set for the reference signal transmissions based on the request.

Some examples of the method, apparatuses, and non-transitory computer-readable medium described herein may further include operations, features, means, or instructions for receiving an indication of the one or more associated operating modes for each reference signal resource set of the one or more reference signal resource sets, where selecting the reference signal resource set may be based on the indication associating the current operating mode with the selected reference signal resource set.

In some examples of the method, apparatuses, and non-transitory computer-readable medium described herein, the selected reference signal resource set may be available for selection by the UE when the one or more operating modes associated with the selected reference signal resource set include the current operating mode of the network entity and the selected reference signal resource set may be unavailable for selection by the UE when the one or more operating modes associated with the selected reference signal resource set do not include the current operating mode of the network entity.

Some examples of the method, apparatuses, and non-transitory computer-readable medium described herein may further include operations, features, means, or instructions for receiving at least one of the reference signal transmissions via the selected reference signal resource set based on the monitoring, where the reference signal transmissions include on-demand PRS transmissions.

Some examples of the method, apparatuses, and non-transitory computer-readable medium described herein may further include operations, features, means, or instructions for receiving an indication of the current operating mode of the network entity, where selecting the reference signal resource set may be based on the indication of the current operating mode.

Some examples of the method, apparatuses, and non-transitory computer-readable medium described herein may further include operations, features, means, or instructions for receiving an indication of a time period in which the reference signal resource set may be available for selection by the UE, where selecting the reference signal resource may be based on the reference signal transmissions being within the time period.

Some examples of the method, apparatuses, and non-transitory computer-readable medium described herein may further include operations, features, means, or instructions for initiating a timer based on receiving the indication, where a duration of the timer corresponds to the time period in which the reference signal resource set may be available for selection by the UE, and where the reference signal resource set may be unavailable for selection by the UE after expiration of the timer.

In some examples of the method, apparatuses, and non-transitory computer-readable medium described herein, a duration of the time period may be based on the current operating mode of the network entity.

In some examples of the method, apparatuses, and non-transitory computer-readable medium described herein, the current operating mode of the network entity includes a power saving mode of the network entity, a traffic level of the network entity, a transmission power of the network entity, a quantity of transmit antennas used by the network entity, a quantity of UEs served by the network entity, or any combination thereof.

In some examples of the method, apparatuses, and non-transitory computer-readable medium described herein, the message indicates one or more of a repetition factor, a time gap, a periodicity, or a muting pattern for each reference signal resource set of the one or more reference signal resource sets.

A method for wireless communication at a network entity is described. The method may include outputting a message that indicates a configuration of one or more reference signal resource sets each associated with one or more operating modes of the network entity, obtaining a request for reference signal transmissions via a reference signal resource set of the one or more reference signal resource sets, the reference signal resource set associated with a current operating mode of the network entity, and outputting the requested reference signal transmissions via the reference signal resource set in accordance with the configuration.

An apparatus for wireless communication is described. The apparatus may include a memory, a transceiver, and at least one processor of a network entity, the at least one processor coupled with the memory and the transceiver. The at least one processor may be configured to cause the apparatus to output, via the transceiver, a message that indicates a configuration of one or more reference signal resource sets each associated with one or more operating modes of the network entity, obtain, via the transceiver, a request for reference signal transmissions via a reference signal resource set of the one or more reference signal resource sets, the reference signal resource set associated with a current operating mode of the network entity, and output, via the transceiver, the requested reference signal transmissions via the reference signal resource set in accordance with the configuration.

Another apparatus for wireless communication is described. The apparatus may include means for outputting a message that indicates a configuration of one or more reference signal resource sets each associated with one or more operating modes of the network entity, means for obtaining a request for reference signal transmissions via a reference signal resource set of the one or more reference signal resource sets, the reference signal resource set associated with a current operating mode of the network entity, and means for outputting the requested reference signal transmissions via the reference signal resource set in accordance with the configuration.

A non-transitory computer-readable medium storing code for wireless communication at a network entity is described. The code may include instructions executable by a processor to output a message that indicates a configuration of one or more reference signal resource sets each associated with one or more operating modes of the network entity, obtain a request for reference signal transmissions via a reference signal resource set of the one or more reference signal resource sets, the reference signal resource set associated with a current operating mode of the network entity, and output the requested reference signal transmissions via the reference signal resource set in accordance with the configuration.

Some examples of the method, apparatuses, and non-transitory computer-readable medium described herein may further include operations, features, means, or instructions for outputting an indication of the one or more associated operating modes for each reference signal resource set of the one or more reference signal resource sets, where obtaining the request may be based on the indication associating the current operating mode with the reference signal resource set.

In some examples of the method, apparatuses, and non-transitory computer-readable medium described herein, the reference signal resource set may be available for reference signal transmissions when the one or more operating modes associated with the reference signal resource set include the current operating mode of the network entity and the reference signal resource set may be unavailable for reference signal transmissions when the one or more operating modes associated with the reference signal resource set do not include the current operating mode of the network entity.

Some examples of the method, apparatuses, and non-transitory computer-readable medium described herein may further include operations, features, means, or instructions for outputting an indication of the current operating mode of the network entity, where obtaining the request may be based on the indication of the current operating mode.

Some examples of the method, apparatuses, and non-transitory computer-readable medium described herein may further include operations, features, means, or instructions for outputting an indication of a time period in which the reference signal resource set may be available for reference signal transmissions, where obtaining the request for reference signal transmissions via the reference signal resource set may be based on the reference signal transmissions being within the time period.

In some examples of the method, apparatuses, and non-transitory computer-readable medium described herein, the time period in which the reference signal resource set may be available corresponds to a duration of a timer and the reference signal resource set may be unavailable for reference signal transmissions after expiration of the timer.

### BRIEF DESCRIPTION OF THE DRAWINGS

FIGS. 1 and 2 illustrate examples of wireless communications systems that support dynamically configuring positioning reference signal (PRS) resources in accordance with one or more aspects of the present disclosure.

FIG. 3 illustrates an example of a resource diagram that supports dynamically configuring PRS resources in accordance with one or more aspects of the present disclosure.

FIG. 4 illustrates an example of a process flow that supports dynamically configuring PRS resources in accordance with one or more aspects of the present disclosure.

FIGS. 5 and 6 show block diagrams of devices that support dynamically configuring PRS resources in accordance with one or more aspects of the present disclosure.

FIG. 7 shows a block diagram of a communications manager that supports dynamically configuring PRS resources in accordance with one or more aspects of the present disclosure.

FIG. 8 shows a diagram of a system including a device that supports dynamically configuring PRS resources in accordance with one or more aspects of the present disclosure.

FIGS. 9 and 10 show block diagrams of devices that support dynamically configuring PRS resources in accordance with one or more aspects of the present disclosure.

FIG. 11 shows a block diagram of a communications manager that supports dynamically configuring PRS resources in accordance with one or more aspects of the present disclosure.

FIG. 12 shows a diagram of a system including a device that supports dynamically configuring PRS resources in accordance with one or more aspects of the present disclosure.

FIGS. 13 through 16 show flowcharts illustrating methods that support dynamically configuring PRS resources in accordance with one or more aspects of the present disclosure.

### DETAILED DESCRIPTION

A wireless communication system may support different positioning methodologies that are based on measurements like time difference of arrival (TDoA), angle of departure (AoD), angle of arrival (AoA), or round trip time (RTT), among other examples. These positioning methodologies may include uplink-based positioning procedures and downlink-based positioning procedures. In downlink based positioning procedures, a user equipment (UE) may obtain positioning information by measuring positioning reference signals (PRS) from a network entity. Downlink based positioning procedures may support scheduled PRS transmissions (e.g., PRS transmissions scheduled by the network) and on demand PRS transmissions (e.g., PRS transmissions requested by the UE).

In some cases, however, the accuracy of downlink-based positioning procedures may be adversely impacted if the network entity changes operating modes or uses different transmission parameters (e.g., settings, configurations) for different PRS transmissions. For example, the UE may be unable to obtain accurate positioning information if the network entity transmits PRSs using fewer transmit antennas or a reduced transmission power (e.g., with respect to previously transmitted PRSs). Thus, some downlink-based positioning procedures may not be appropriate for wireless communications systems in which network entities frequently transition between different operating modes.

Aspects of the present disclosure support techniques for configuring different on-demand PRS resource sets for different operating modes of a network entity. For example, some on-demand PRS resource sets may be available to the UE (e.g., the UE may be able to request PRS transmissions on some on-demand PRS resource sets) when the network entity is in a first operating mode, while other on-demand PRS resource sets may be available to the UE when the network entity transitions to a second operating mode (e.g., a power saving mode). The UE may be unable to request on-demand PRS transmissions from the network entity on PRS resource sets that are not configured (e.g., available) for a current operating mode of the network entity.

In some examples, the UE may receive an indication of which on-demand PRS resource sets are available for each operating mode of the network entity. Accordingly, the UE may request PRS transmissions on one or more of the on-demand PRS resource sets that are available for a current operating mode of the network entity. In some examples, the current operating mode of the network entity may be implicitly determined by the UE or explicitly signaled by the network entity. The current operating mode of the network entity may be defined by a power saving mode of the network entity, a transmission power of the network entity, a number of transmit antennas used by the network entity, a traffic level of the network entity, or a number of UEs served by network entity, among other examples.

Aspects of the present disclosure may be implemented to realize one or more of the following advantages. The described techniques may provide for improving on-demand PRS transmission procedures between a UE and a network entity. More specifically, the techniques described herein may enable a network entity to configure different on-demand PRS resource sets for different operating modes of the network entity. For example, if the network entity enters a power saving mode, the network entity may configure a UE with on-demand PRS resource sets that include fewer PRS resources or that span fewer time slots. As a result, the network entity may attain greater power savings without adversely impacting the accuracy or reliability of PRS measurement procedures at the UE.

Aspects of the disclosure are initially described in the context of wireless communications systems, resource diagrams, and process flows. Aspects of the disclosure are further illustrated by and described with reference to apparatus diagrams, system diagrams, and flowcharts that relate to dynamically configuring PRS resources.

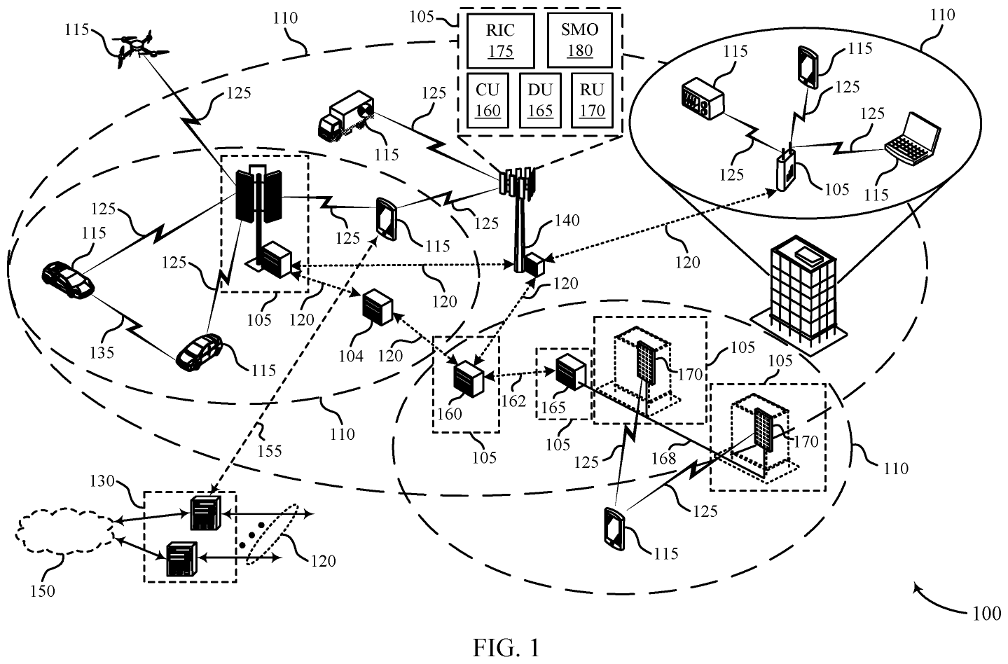

FIG. 1 illustrates an example of a wireless communications system 100 that supports dynamically configuring PRS resources in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support dynamically configuring PRS resources, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems may support RAT-dependent NR positioning technologies. Positioning technologies supported in 5G-NR may include downlink-based positioning procedures, uplink-based positioning procedures, and procedures that include both uplink-based and downlink-based positioning mechanisms. Some downlink-based positioning procedures may be based on downlink TDoA or downlink AoD, among other examples. Similarly, uplink-based positioning procedures may be based on uplink TDoA or uplink AoA, among other examples. Positioning procedures that involve a combination of uplink and downlink signaling may be based on RTT or multi-RTT (e.g., RTT with respect to neighboring cells). Some wireless communications systems may also support Enhanced Cell-ID (E-CID) positioning procedures that are based on radio resource management (RRM) measurements. In some on-demand PRS-based positioning procedures, a network entity 105 may provide a UE 115 and a location management function (LMF) with a set of possible on-demand PRS configurations. Accordingly, the LMF or the UE 115 may select one of the possible PRS configurations for use in a subsequent PRS transmission procedure.

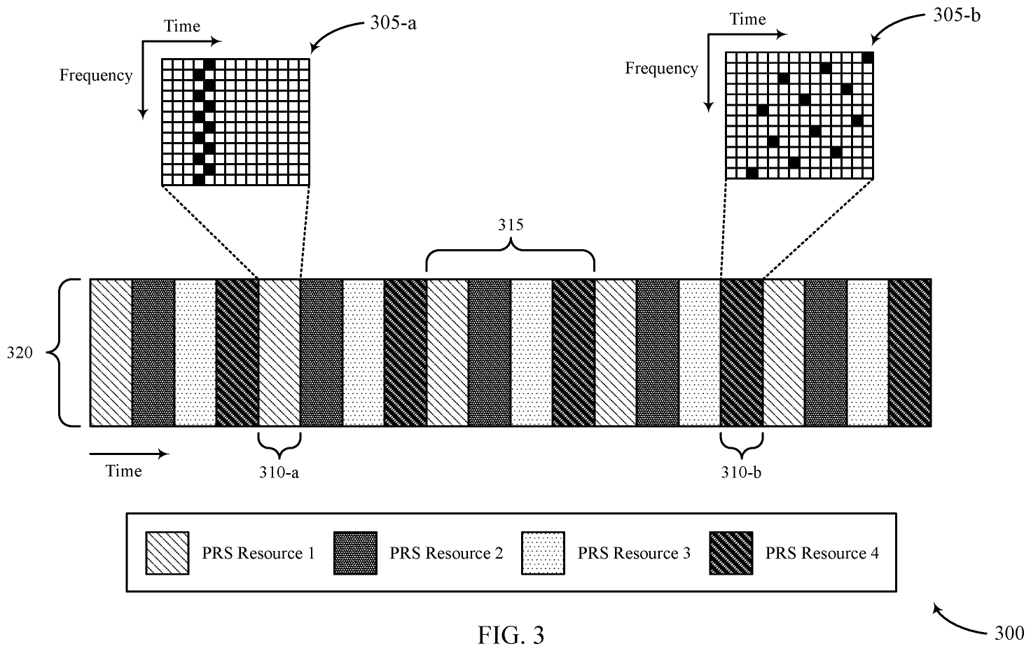

Some wireless communications systems may also support different downlink PRS resource patterns within a slot. For example, a downlink PRS resource may span a number (e.g., 2, 4, 6, 12) of consecutive symbols within a slot, and may have a frequency-domain staggered pattern. These patterns may include different frequency combinations (e.g., Comb-2, Comb-4, Comb-6, Comb-12) and time durations (e.g., 2 symbols, 4 symbols, 6 symbols, 12 symbols). Examples of different downlink PRS resource patterns are described with reference to FIG. 3. A downlink PRS resource can be configured in various downlink or flexible symbols within a slot. In some cases, all resource elements (REs) within a downlink PRS resource may have a constant energy per resource element (EPRE) value.

A positioning frequency layer may refer to a combination of PRS resource sets (across one or more TRPs) with the same subcarrier spacing, cyclic prefix type, point-A (e.g., ARFCN-ValueNR), downlink PRS bandwidth, starting physical resource block (PRB), center frequency, and frequency combination size. All numerologies supported for physical downlink shared channel (PDSCH) resources may also be supported for PRS resources. The downlink bandwidth of PRS resource sets may be configured as a value between 24 and 272 PRBs with a granularity of 4 PRBs. Some wireless communications systems may support up to 4 different positioning frequency layers. A PRS resource set may refer to a combination of PRS resources (across one TRP) with the same periodicity (e.g., 2^{m} {4, 5, 8, 10, 16, 20, 32, 40, 64, 80, 160, 320, 640, 1280, 2560, 5120, 10240}slots, with μ=0, 1, 2, 3), a common muting pattern configuration, and the same repetition factor across slots (e.g., {1, 2, 4, 6, 8, 16, 32}slots). Some wireless communications systems may support up to 2 PRS resource sets per TRP (×3) per frequency layer.

Some wireless communications systems may also support different downlink PRS resource repetition factors and beam sweeping configurations. Downlink PRS resource repetitions may support receive beam sweeping across repetitions, coverage enhancements (by increasing overall gain), and intra-instance muting. Downlink PRS resource repetition factors may be configured using a PRS resource repetition factor field and a PRS resource time gap field. The PRS resource repetition factor field (e.g., PRS-ResourceRepetitionFactor) may indicate a number of times each PRS resource is repeated within a single instance of a PRS resource set. This field may have values of 1, 2, 4, 6, 8, 16, or 32. The PRS resource time gap field (e.g., PRS-ResourceTimeGap) may indicate an offset (in slots) between two repeated instances of a downlink PRS resource corresponding to the same PRS resource identifier within a single instance of the downlink PRS resource set. This field may have values of 1, 2, 4, 8, 16, or 32. The time duration spanned by one downlink PRS resource set that includes repeated downlink PRS resources may be less than or equal to a periodicity (e.g., PRS-Periodicity) of the downlink PRS resource.

Aspects of the wireless communications system 100 may be implemented to realize one or more of the following advantages. The techniques described with reference to FIG. 1 may provide for improving on-demand PRS transmission procedures between a UE 115 and a network entity 105. More specifically, the described techniques may enable a network entity 105 to configure different on-demand PRS resource sets for different operating modes of the network entity 105. For example, if the network entity 105 enters a power saving mode (e.g., a low-power state), the network entity 105 may configure the UE 115 with on-demand PRS resource sets that include fewer PRS resources or that span fewer time slots. As a result, the network entity 105 may attain greater power savings without adversely impacting the accuracy or reliability of PRS measurement procedures at the UE 115.

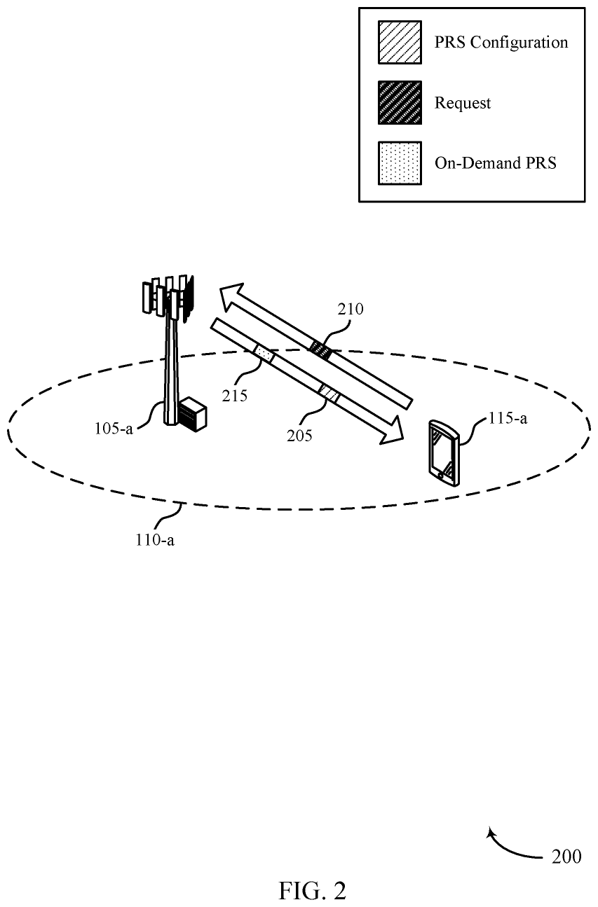

FIG. 2 illustrates an example of a wireless communications system 200 that supports dynamically configuring PRS resources in accordance with one or more aspects of the present disclosure. The wireless communications system 200 may implement or be implemented by aspects of wireless communications system 100. For example, the wireless communications system 200 may include a UE 115-a and a network entity 105-a, which may be examples of corresponding devices described with reference to FIG. 1. The UE 115-a and the network entity 105-a may communicate within a coverage area 110-a, which may be an example of a coverage area 110 described with reference to FIG. 1. In the wireless communications system 200, the UE 115-a may request on-demand PRS transmissions from the network entity 105-a on a PRS resource set that is available for a current operating mode of the network entity 105-a.

Some wireless communications systems (e.g., green networks) may support techniques to reduce network power consumption. These power savings may, in some examples, occur during periods with low traffic volume (e.g., low load scenarios with low data arrival rates and fewer connected UEs). In such examples, network entities can reduce overall power consumption by using lower transmission powers or fewer antennas. However, using reduced transmission powers and fewer antennas (e.g., entering a network power saving mode) may impact the accuracy of positioning procedures at other communication devices. Moreover, if there are relatively few connected devices, the network can experience greater power savings by reducing extraneous PRS transmissions.

Aspects of the wireless communications system 200 may support configuring different on-demand PRS resource sets for different operating modes of the network entity 105-a. For example, the network entity 105-a may provide the UE 115-a (and a corresponding LMF) with different available on-demand PRS resource sets that correspond to a current operating mode of the network entity 105-a. Thus, if the network entity 105-a enters a power saving mode (e.g., sleep mode), the network entity 105-a may configure the UE 115-a with a PRS resource set that is compatible with the power saving mode of the network entity 105-a. In some examples, the network entity 105-a may change or update which PRS resource sets are available to the UE 115-a based on a number of UEs served by the network entity 105-a and traffic levels associated with these UEs (e.g., because these factors may determine what transmit antennas or transmission powers the network entity 105-a uses).

The network entity 105-a may also indicate which network power saving modes are applicable to (e.g., associated with, available for) each PRS resource set. For example, if the network entity 105-a supports 4 different network power saving modes, the network entity 105-a may which (if any) of the 4 different operating modes are applicable to a specific PRS resource set. Each of the PRS resource sets configured by the network entity 105-a may be available in zero, one, or multiple different power saving modes of the network entity 105-a. As described herein, the network entity 105-a may change operating modes frequently (e.g., to adapt to different traffic levels). To account for these changes, the network entity 105-a may configure an expiration timer for each configured PRS resource set. By configuring a PRS resource set to expire after a time period, the network entity 105-a may have more flexibility to adapt PRS resource configurations based on current network activity levels. In some examples, this timer may depend on the operating mode of the network entity 105-a. After expiration of the timer, the LMF and the UE 115-a may determine that no PRS resources are available (until the network entity 105-a signals additional PRS resources).

In the example of FIG. 2, the UE 115-a may receive an indication of a PRS configuration 205 from the network entity 105-a. As described herein, the PRS configuration 205 may indicate a repetition factor, a time gap, a periodicity, or a muting pattern for one or more PRS resource sets. The PRS configuration 205 may also indicate one or more operating modes of the network entity 105-a that are applicable to each of the one or more PRS resource sets. Additionally or alternatively, the PRS configuration 205 may indicate a current operating mode of the network entity 105-a or an expiration timer associated with the one or more PRS resource sets. The UE 115-a may select one of the PRS resource sets indicated by the PRS configuration 205, and may transmit a request 210 to receive on-demand PRS transmissions 215 via the selected PRS resource set. Accordingly, the network entity 105-a may transmit the on-demand PRS transmissions 215 to the UE 115-a via the selected PRS resource set.

Aspects of the wireless communications system 200 may be implemented to realize one or more of the following advantages. The techniques described with reference to FIG. 2 may improve on-demand PRS transmission procedures between the UE 115-a and the network entity 105-a. More specifically, the described techniques may enable the network entity 105-a to configure different on-demand PRS resource sets for different operating modes of the network entity 105-a. For example, if the network entity 105-a enters a power saving mode (e.g., sleep mode), the network entity 105-a may configure the UE 115-a with on-demand PRS resource sets that include fewer PRS resources or that span fewer time slots. As a result, the network entity 105-a may attain greater power savings without adversely impacting the accuracy or reliability of PRS measurement procedures at the UE 115-a.

FIG. 3 illustrates an example of a resource diagram 300 that supports dynamically configuring PRS resources in accordance with one or more aspects of the present disclosure. The resource diagram 300 may implement or be implemented by aspects of the wireless communications system 100 or the wireless communications system 200. For example, the resource diagram 300 may be implemented by a UE 115 or a network entity 105, as described with reference to FIGS. 1 and 2. The resource diagram 300 may illustrate an example of an on-demand PRS resource set configuration, which may include a combination of different PRS resources. The on-demand PRS resource set configuration illustrated in the example of FIG. 3 may be applicable to (e.g., available for) one or more operating modes (e.g., power saving modes, transmission powers, traffic levels) of a network entity.

As described with reference to FIGS. 1 and 2, a UE may receive an indication of a configuration for one or more PRS resource sets that are each associated with one or more operating modes of a network entity. In some examples, the UE may also receive signaling that indicates a current operating mode of the network entity or an expiration timer for the one or more PRS resource sets. The UE may select a PRS resource set from the one or more PRS resource sets based on the current operating mode of the network entity and the expiration timer for the PRS resource sets. Accordingly, the UE may transmit a request to receive on-demand PRS transmissions via the selected PRS resource set. After transmitting the request, the UE may monitor the selected PRS resource set for the requested on-demand PRS transmissions

As illustrated in the example of FIG. 3, a PRS resource set 320 may include a combination of different PRS resources arranged in a specific pattern. The PRS resource set 320 may be associated with a time gap 315 of 4 slots and a repetition factor of 4. The time gap 315 may refer to a number of slots between instances of a PRS resource. Thus, there may be 4 slots between a first instance of PRS resource 3 and a second instance of PRS resource 3. The repetition factor may refer to a number of times that a PRS resource is repeated within the PRS resource set 320. For example, there may be 4 instances of PRS resource 2 in the PRS resource set 320. Although illustrated with 4 different PRS resources, it is to be understood that the PRS resource set 320 may include any number of PRS resources.

The PRS resource set 320 may include a PRS resource 305-a (e.g., PRS resource 1) and a PRS resource 305-b (e.g., PRS resource 4). The PRS resource 305-a may span a slot 310-a, while the PRS resource 305-b may span a slot 310-b. The PRS resource 305-a may correspond to a Comb-2 pattern with 2 symbols, whereas the PRS resource 305-b may correspond to a Comb-12 pattern with 12 symbols. The PRS resource 305-a may have a downlink PRS resource offset of 3 symbols and a coefficient matrix of {0, 1}, while the PRS resource 305-b may have a downlink PRS resource offset of 2 symbols and a coefficient matrix of {0, 6, 3, 9, 1, 7, 4, 10, 2, 8, 5, 11}. The coefficient matrices associated with the PRS resources 305 may indicate which subcarriers are used (for PRS transmissions) in each symbol of the slots 310.

Aspects of the resource diagram 300 may be implemented to realize one or more of the following advantages. The techniques described with reference to FIG. 3 may improve on-demand PRS transmission procedures between a UE and a network entity. More specifically, the described techniques may enable a network entity to configure different on-demand PRS resource sets for different operating modes of the network entity. For example, if the network entity is experiencing relatively low traffic volume, the network entity may configure a UE with on-demand PRS resource sets that include fewer PRS resources or that span fewer time slots (e.g., to reduce the number of PRS transmissions performed by the network entity). As a result, the network entity may attain greater power savings without adversely impacting the accuracy or reliability of PRS measurement procedures at the UE.

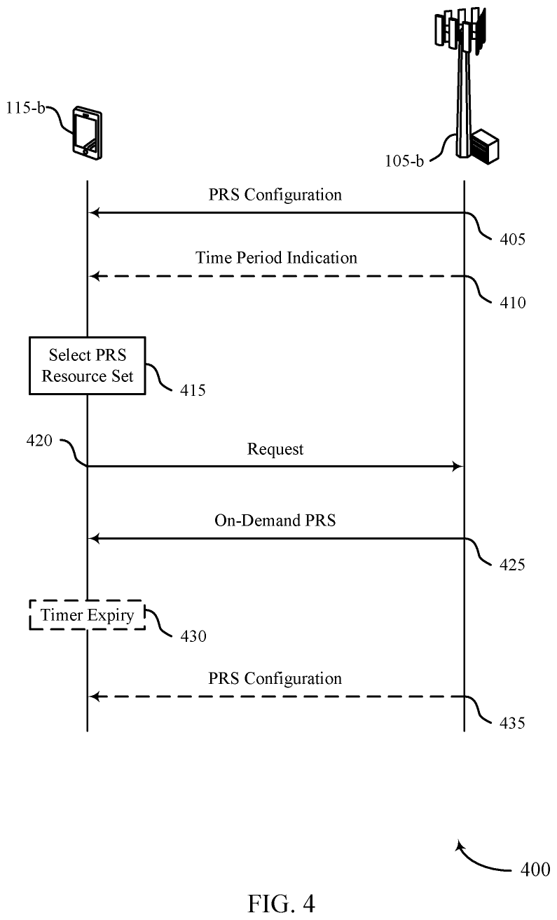

FIG. 4 illustrates an example of a process flow 400 that supports dynamically configuring PRS resources in accordance with one or more aspects of the present disclosure. The process flow 400 may implement or be implemented by aspects of the wireless communications system 100 or the wireless communications system 200. For example, the process flow 400 may include a UE 115-b and a network entity 105-b, which may be examples of corresponding devices described with reference to FIGS. 1 and 2. In the following description of the process flow 400, operations between the UE 115-b and the network entity 105-b may be performed in a different order or at a different time than as shown. Additionally or alternatively, some operations may be omitted from the process flow 400, and other operations may be added to the process flow 400.

At 405, the UE 115-b may receive a message that indicates a configuration of one or more PRS resource sets that are each associated with one or more operating modes of the network entity 105-b. The message may indicate (e.g., the configuration may include) one or more of a repetition factor, a time gap, a periodicity, or a muting pattern for each of the one or more PRS resource sets. In some examples, the message may include an indication of the one or more associated operating modes for each of the one or more PRS resource sets. Additionally or alternatively, the message may indicate a current operating mode of the network entity 105-b. As described herein, the current operating mode of the network entity 105-b may refer to a power saving mode of the network entity 105-b, a traffic level of the network entity 105-b, a quantity of transmit antennas used by the network entity 105-b, a transmission power of the network entity 105-b, a quantity of UEs served by the network entity 105-b, or any combination thereof.

A PRS resource set may be available for selection by the UE 115-b when the one or more operating modes associated with the PRS resource set include the current operating mode of the network entity 105-b. That is, the UE 115-b may be able to request on-demand PRS transmissions from the network entity 105-b on PRS resource sets associated with the current operating mode of the network entity 105-b. In contrast, a PRS resource set may be unavailable for selection by the UE 115-b when the current operating mode of the network entity 105-b is different from (e.g., not included in) the one or more operating modes associated with the PRS resource set.

At 410, the UE 115-b may optionally receive an indication of a time period in which a PRS resource set is available for selection by the UE 115-b (e.g., a duration of a timer, where the PRS resource set is available for selection by the UE 115-b until expiration of the timer). In some examples, the time period may be indicated (e.g., signaled) in the configuration for the one or more PRS resource sets. The time period may be a function of the current operating mode of the network entity 105-b (e.g., different operating modes may be associated with different timer durations). Upon receiving an indication of the time period, the UE 115-b may initiate a timer (e.g., an expiration timer) for the PRS resource set. A duration of the timer may correspond to the time period in which the PRS resource set is available to the UE 115-b. The PRS resource set may be unavailable to the UE 115-b after expiration of the timer. The UE 115-b may initiate the timer upon receiving the indication of the timer duration at 410 or upon identifying that the network entity 105-b has entered into the operating mode associated with the timer (e.g., upon receiving an indication a current operating mode of the network entity 105-b, the current operating mode being associated with the timer).

At 415, the UE 115-b may select a PRS resource set from the one or more PRS resource sets based on the configuration and the current operating mode of the network entity 105-b. More specifically, the UE 115-b may select a PRS resource set that corresponds to a current operating mode of the network entity 105-b (e.g., as indicated by the configuration). The UE 115-b may select the PRS resource set prior to expiration of a timer associated with the selected PRS resource set (e.g., while the PRS resource set is available to the UE 115-b). At 420, the UE 115-b may transmit a request to receive on-demand PRS transmissions from the network entity 105-b on the selected PRS resource set. At 425, the UE 115-b may monitor the selected PRS resource set for on-demand PRS transmissions in accordance with the request.

In some examples, the UE 115-b may determine that a timer associated with the selected PRS resource set has expired at 430. Accordingly, the UE 115-b may determine that the selected PRS resource set is no longer available to the UE 115-b, and may refrain from transmitting subsequent requests for PRS transmissions on the selected PRS resource set. The network entity 105-b may, in some examples, signal a second PRS configuration to the UE 115-b at 435. For example, if the network entity 105-b enters a power saving mode or adjusts transmission settings (e.g., transmission powers, transmit antennas), the network entity 105-b may signal one or more PRS resource sets that are applicable to (e.g., available for, compatible with) a current operating mode of the network entity 105-b.

Aspects of the process flow 400 may be implemented to realize one or more of the following advantages. The techniques described with reference to FIG. 4 may improve on-demand PRS transmission procedures between the UE 115-b and the network entity 105-b. More specifically, the described techniques may enable the network entity 105-b to configure different on-demand PRS resource sets for different operating modes of the network entity 105-b. For example, if the network entity 105-b changes operating modes (e.g., by using fewer transmit antennas), the network entity 105-b may configure the UE 115-b with on-demand PRS resource sets that include fewer PRS resources or that span fewer time slots. As a result, the network entity 105-b may attain greater power savings without adversely impacting the accuracy or reliability of PRS measurement procedures at the UE 115-b.

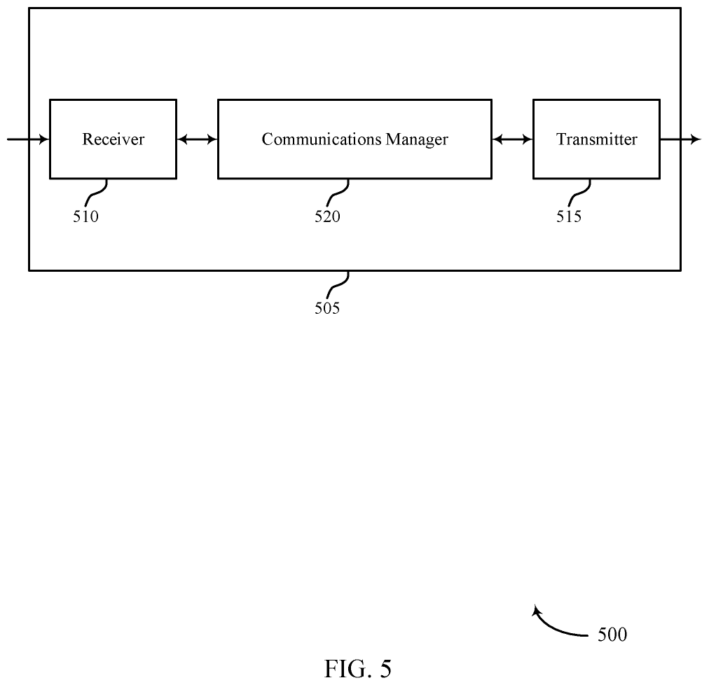

FIG. 5 shows a block diagram 500 of a device 505 that supports dynamically configuring PRS resources in accordance with one or more aspects of the present disclosure. The device 505 may be an example of aspects of a UE 115, as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamically configuring PRS resources). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamically configuring PRS resources). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of dynamically configuring PRS resources, as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations, as described herein.

The communications manager 520 may support wireless communication at the device 505 accordance with examples disclosed herein. For example, the communications manager 520 may be configured as or otherwise support a means for receiving a message that indicates a configuration of one or more reference signal resource sets each associated with one or more operating modes of a network entity. The communications manager 520 may be configured as or otherwise support a means for selecting a reference signal resource set from the one or more reference signal resource sets based on a current operating mode of the network entity. The communications manager 520 may be configured as or otherwise support a means for transmitting a request to receive reference signal transmissions via the selected reference signal resource set. The communications manager 520 may be configured as or otherwise support a means for monitoring the selected reference signal resource set for the reference signal transmissions based on the request.

By including or configuring the communications manager 520 in accordance with examples described herein, the device 505 (e.g., a processor controlling or otherwise coupled with the receiver 510, the transmitter 515, the communications manager 520, or any combination thereof) may support techniques for more efficient utilization of communication resources and reduced power consumption by using on-demand PRS resource sets that are compatible with (e.g., available for) a current operating mode of a network entity.

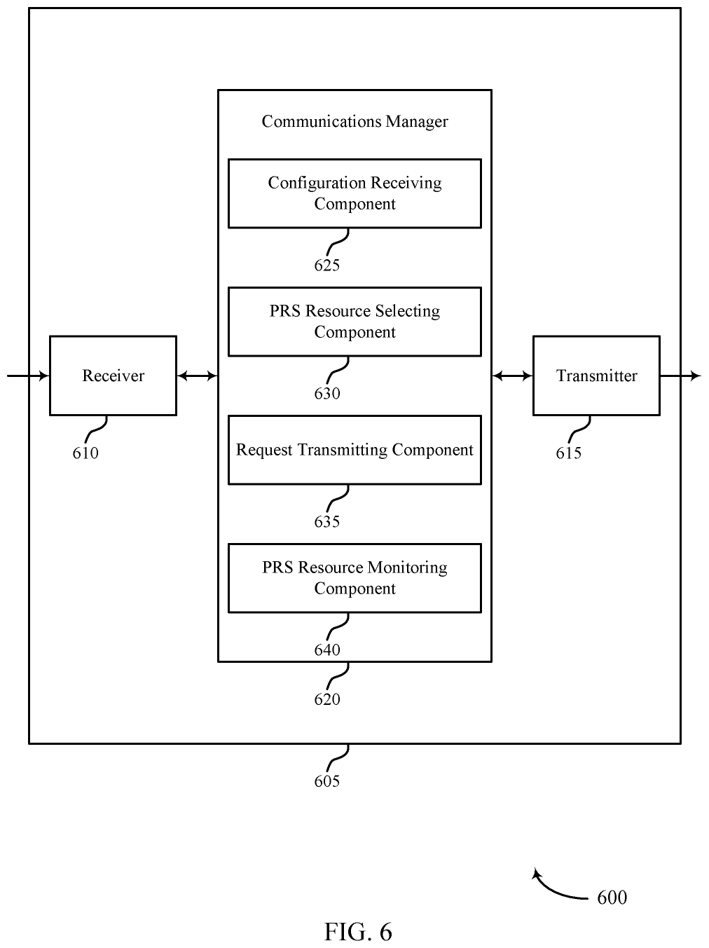

FIG. 6 shows a block diagram 600 of a device 605 that supports dynamically configuring PRS resources in accordance with one or more aspects of the present disclosure. The device 605 may be an example of aspects of a device 505 or a UE 115, as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to dynamically configuring PRS resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dynamically configuring PRS resources). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of dynamically configuring PRS resources, as described herein. For example, the communications manager 620 may include a configuration receiving component 625, an PRS resource selecting component 630, a request transmitting component 635, an PRS resource monitoring component 640, or any combination thereof. The communications manager 620 may be an example of aspects of a communications manager 520, as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations, as described herein.

The communications manager 620 may support wireless communication at the device 605 in accordance with examples disclosed herein. The configuration receiving component 625 may be configured as or otherwise support a means for receiving a message that indicates a configuration of one or more reference signal resource sets each associated with one or more operating modes of a network entity. The PRS resource selecting component 630 may be configured as or otherwise support a means for selecting a reference signal resource set from the one or more reference signal resource sets based on a current operating mode of the network entity. The request transmitting component 635 may be configured as or otherwise support a means for transmitting a request to receive reference signal transmissions via the selected reference signal resource set. The PRS resource monitoring component 640 may be configured as or otherwise support a means for monitoring the selected reference signal resource set for the reference signal transmissions based on the request.

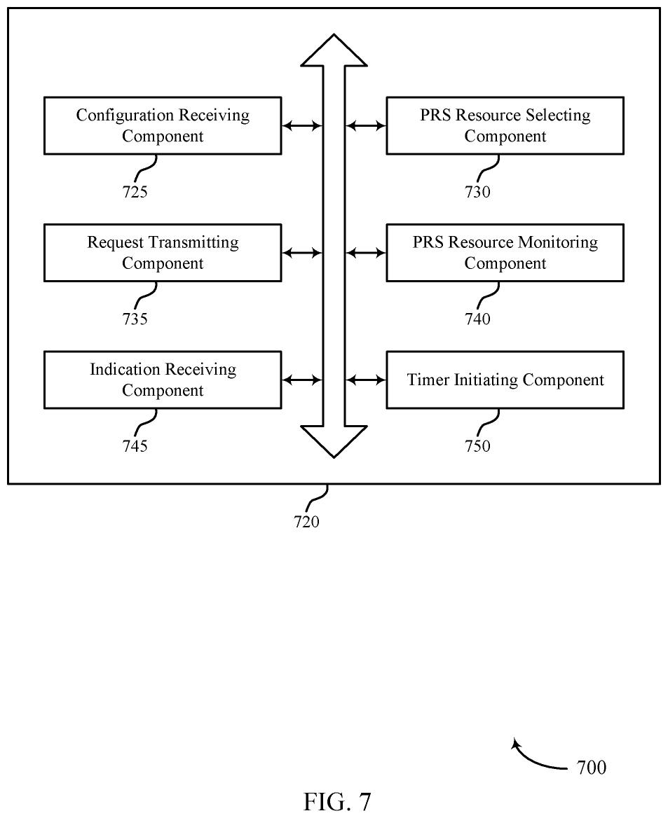

FIG. 7 shows a block diagram 700 of a communications manager 720 that supports dynamically configuring PRS resources in accordance with one or more aspects of the present disclosure. The communications manager 720 may be an example of aspects of a communications manager 520, a communications manager 620, or both, as described herein. The communications manager 720, or various components thereof, may be an example of means for performing various aspects of dynamically configuring PRS resources, as described herein. For example, the communications manager 720 may include a configuration receiving component 725, an PRS resource selecting component 730, a request transmitting component 735, an PRS resource monitoring component 740, an indication receiving component 745, a timer initiating component 750, or any combination thereof. Each of these components may communicate, directly or indirectly, with one another (e.g., via one or more buses).

The communications manager 720 may support wireless communication at a UE in accordance with examples disclosed herein. The configuration receiving component 725 may be configured as or otherwise support a means for receiving a message that indicates a configuration of one or more reference signal resource sets each associated with one or more operating modes of a network entity. The PRS resource selecting component 730 may be configured as or otherwise support a means for selecting a reference signal resource set from the one or more reference signal resource sets based on a current operating mode of the network entity. The request transmitting component 735 may be configured as or otherwise support a means for transmitting a request to receive reference signal transmissions via the selected reference signal resource set. The PRS resource monitoring component 740 may be configured as or otherwise support a means for monitoring the selected reference signal resource set for the reference signal transmissions based on the request.

In some examples, the indication receiving component 745 may be configured as or otherwise support a means for receiving an indication of the one or more associated operating modes for each reference signal resource set of the one or more reference signal resource sets, where selecting the reference signal resource set is based on the indication associating the current operating mode with the selected reference signal resource set.

In some examples, the selected reference signal resource set is available for selection by the UE when the one or more operating modes associated with the selected reference signal resource set include the current operating mode of the network entity. In some examples, the selected reference signal resource set is unavailable for selection by the UE when the one or more operating modes associated with the selected reference signal resource set do not include the current operating mode of the network entity.

In some examples, the PRS resource monitoring component 740 may be configured as or otherwise support a means for receiving at least one of the reference signal transmissions via the selected reference signal resource set based on the monitoring, where the reference signal transmissions include on-demand PRS transmissions.

In some examples, the indication receiving component 745 may be configured as or otherwise support a means for receiving an indication of the current operating mode of the network entity, where selecting the reference signal resource set is based on the indication of the current operating mode.

In some examples, the indication receiving component 745 may be configured as or otherwise support a means for receiving an indication of a time period in which the reference signal resource set is available for selection by the UE, where selecting the reference signal resource set is based on the reference signal transmissions being within the time period.

In some examples, the timer initiating component 750 may be configured as or otherwise support a means for initiating a timer based on receiving the indication, where a duration of the timer corresponds to the time period in which the reference signal resource set is available for selection by the UE, and where the reference signal resource set is unavailable for selection by the UE after expiration of the timer.

In some examples, a duration of the time period is based on the current operating mode of the network entity. In some examples, the current operating mode of the network entity includes a power saving mode of the network entity, a traffic level of the network entity, a transmission power of the network entity, a quantity of transmit antennas used by the network entity, a quantity of UEs served by the network entity, or any combination thereof. In some examples, the message indicates (e.g., the configuration includes) one or more of a repetition factor, a time gap, a periodicity, or a muting pattern for each reference signal resource set of the one or more reference signal resource sets.

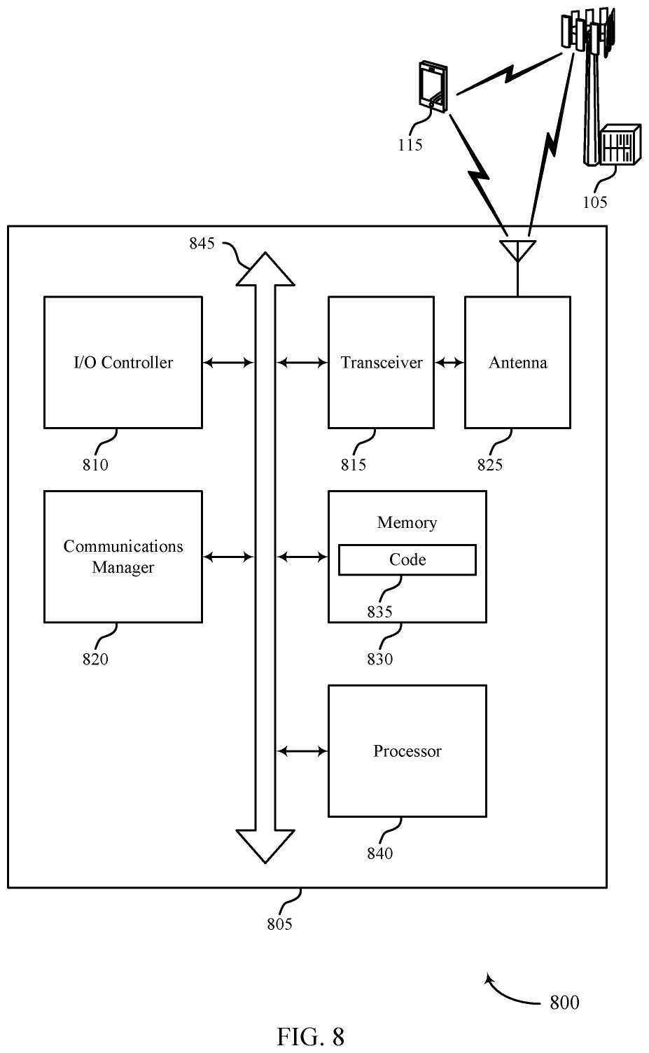

FIG. 8 shows a diagram of a system 800 including a device 805 that supports dynamically configuring PRS resources in accordance with one or more aspects of the present disclosure. The device 805 may be an example of or include the components of a device 505, a device 605, or a UE 115, as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links, as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting dynamically configuring PRS resources). For example, the device 805 or a component of the device 805 may include a processor 840 and memory 830 coupled with or to the processor 840, the processor 840 and memory 830 configured to perform various functions described herein.

The communications manager 820 may support wireless communication at the device 805 in accordance with examples disclosed herein. For example, the communications manager 820 may be configured as or otherwise support a means for receiving a message that indicates a configuration of one or more reference signal resource sets each associated with one or more operating modes of a network entity. The communications manager 820 may be configured as or otherwise support a means for selecting a reference signal resource set from the one or more reference signal resource sets based on a current operating mode of the network entity. The communications manager 820 may be configured as or otherwise support a means for transmitting a request to receive reference signal transmissions via the selected reference signal resource set. The communications manager 820 may be configured as or otherwise support a means for monitoring the selected reference signal resource set for the reference signal transmissions based on the request.

By including or configuring the communications manager 820 in accordance with examples described herein, the device 805 may support techniques for improved on-demand PRS transmission procedures between the device 805 and a network entity. More specifically, the described techniques may enable the network entity to configure different on-demand PRS resource sets for different operating modes of the network entity. For example, if the network entity changes operating modes (e.g., by using fewer transmit antennas), the network entity may configure the device 805 with on-demand PRS resource sets that include fewer PRS resources or span fewer time slots. As a result, the network entity may attain greater power savings without adversely impacting the accuracy or reliability of PRS measurement procedures at the device 805.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of dynamically configuring PRS resources, as described herein, or the processor 840 and the memory 830 may be otherwise configured to perform or support such operations.

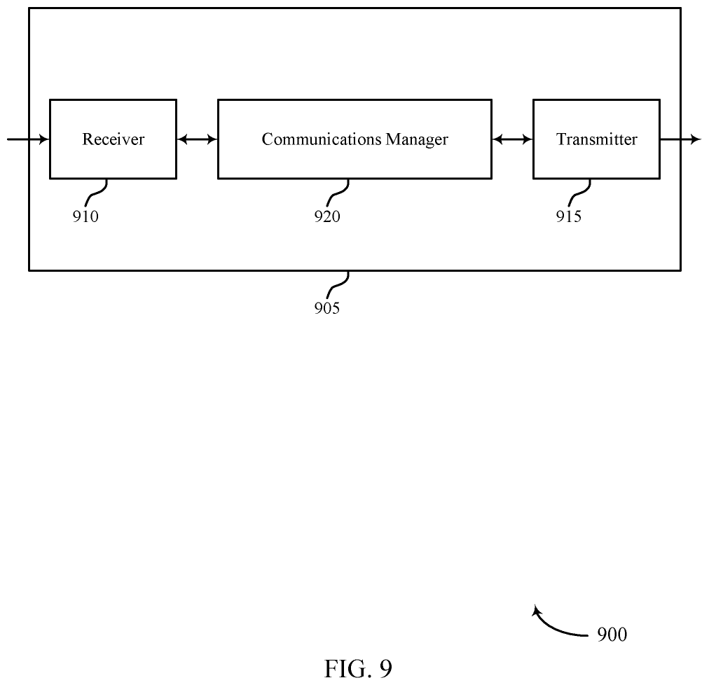

FIG. 9 shows a block diagram 900 of a device 905 that supports dynamically configuring PRS resources in accordance with one or more aspects of the present disclosure. The device 905 may be an example of aspects of a network entity 105, as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of dynamically configuring PRS resources, as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations, as described herein.

The communications manager 920 may support wireless communication at the device 905 in accordance with examples disclosed herein. For example, the communications manager 920 may be configured as or otherwise support a means for outputting a message that indicates a configuration of one or more reference signal resource sets each associated with one or more operating modes of the device 905. The communications manager 920 may be configured as or otherwise support a means for obtaining a request for reference signal transmissions via a reference signal resource set of the one or more reference signal resource sets, the reference signal resource set associated with a current operating mode of the device 905. The communications manager 920 may be configured as or otherwise support a means for outputting the requested reference signal transmissions via the reference signal resource set in accordance with the configuration.

By including or configuring the communications manager 920 in accordance with examples described herein, the device 905 (e.g., a processor controlling or otherwise coupled with the receiver 910, the transmitter 915, the communications manager 920, or any combination thereof) may support techniques for more efficient utilization of communication resources and reduced power consumption by configuring a UE to use on-demand PRS resource sets that are compatible with (e.g., applicable to, associated with) a current operating mode of the device 905.

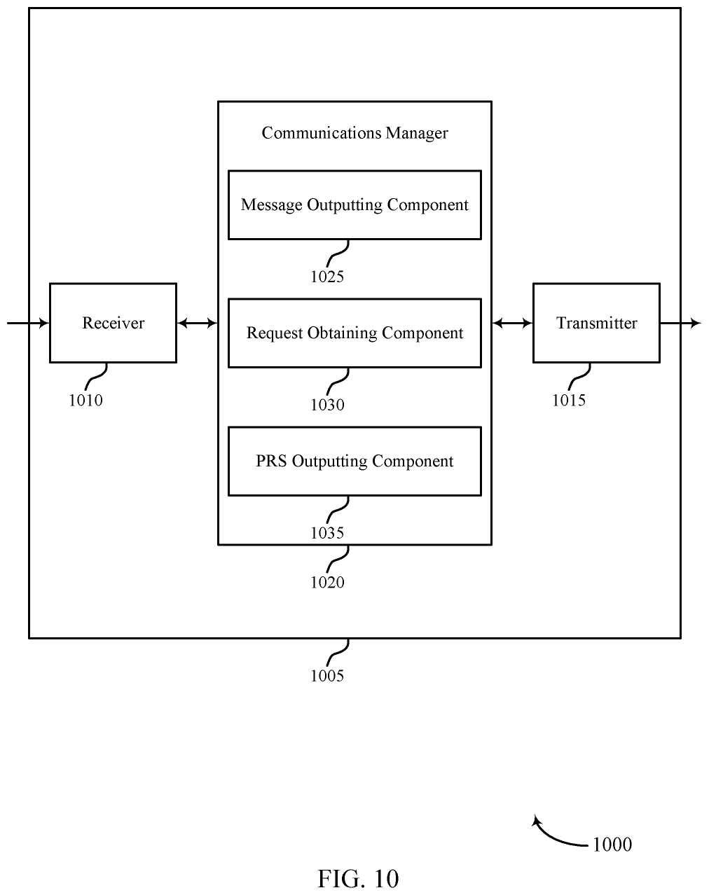

FIG. 10 shows a block diagram 1000 of a device 1005 that supports dynamically configuring PRS resources in accordance with one or more aspects of the present disclosure. The device 1005 may be an example of aspects of a device 905 or a network entity 105, as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of dynamically configuring PRS resources, as described herein. For example, the communications manager 1020 may include a message outputting component 1025, a request obtaining component 1030, an PRS outputting component 1035, or any combination thereof. The communications manager 1020 may be an example of aspects of a communications manager 920, as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations, as described herein.

The communications manager 1020 may support wireless communication at the device 1005 in accordance with examples disclosed herein. The message outputting component 1025 may be configured as or otherwise support a means for outputting a message that indicates a configuration of one or more reference signal resource sets each associated with one or more operating modes of the device 1005. The request obtaining component 1030 may be configured as or otherwise support a means for obtaining a request for reference signal transmissions via a reference signal resource set of the one or more reference signal resource sets, the reference signal resource set associated with a current operating mode of the device 1005. The PRS outputting component 1035 may be configured as or otherwise support a means for outputting the requested reference signal transmissions via the reference signal resource set in accordance with the configuration.

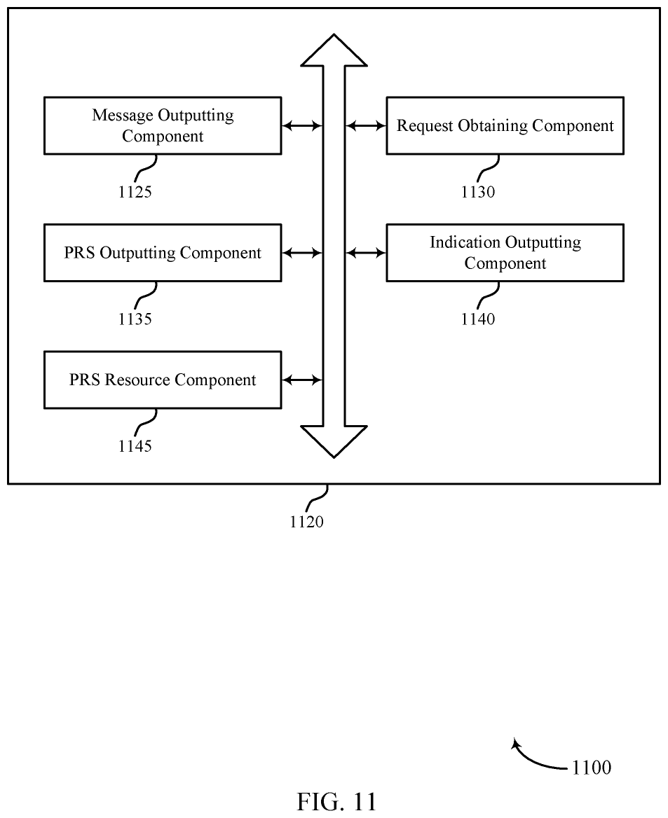

FIG. 11 shows a block diagram 1100 of a communications manager 1120 that supports dynamically configuring PRS resources in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of dynamically configuring PRS resources, as described herein. For example, the communications manager 1120 may include a message outputting component 1125, a request obtaining component 1130, an PRS outputting component 1135, an indication outputting component 1140, an PRS resource component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples disclosed herein. The message outputting component 1125 may be configured as or otherwise support a means for outputting a message that indicates a configuration of one or more reference signal resource sets each associated with one or more operating modes of the network entity. The request obtaining component 1130 may be configured as or otherwise support a means for obtaining a request for reference signal transmissions via a reference signal resource set of the one or more reference signal resource sets, the reference signal resource set associated with a current operating mode of the network entity. The PRS outputting component 1135 may be configured as or otherwise support a means for outputting the requested reference signal transmissions via the reference signal resource set in accordance with the configuration.

In some examples, the indication outputting component 1140 may be configured as or otherwise support a means for outputting an indication of the one or more associated operating modes for each reference signal resource set of the one or more reference signal resource sets, where obtaining the request is based on the indication associating the current operating mode with the reference signal resource set.

In some examples, the reference signal resource set is available for reference signal transmissions when the one or more operating modes associated with the reference signal resource set include the current operating mode of the network entity. In some examples, the reference signal resource set is unavailable for reference signal transmissions when the one or more operating modes associated with the reference signal resource set do not include the current operating mode of the network entity.

In some examples, the indication outputting component 1140 may be configured as or otherwise support a means for outputting an indication of the current operating mode of the network entity, where obtaining the request is based on the indication of the current operating mode.

In some examples, the indication outputting component 1140 may be configured as or otherwise support a means for outputting an indication of a time period in which the reference signal resource set is available for reference signal transmissions, where obtaining the request for reference signal transmissions via the reference signal resource set is based on the reference signal transmissions being within the time period.

In some examples, the time period in which the reference signal resource set is available corresponds to a duration of a timer. In some examples, the reference signal resource set is unavailable for reference signal transmissions after expiration of the timer.

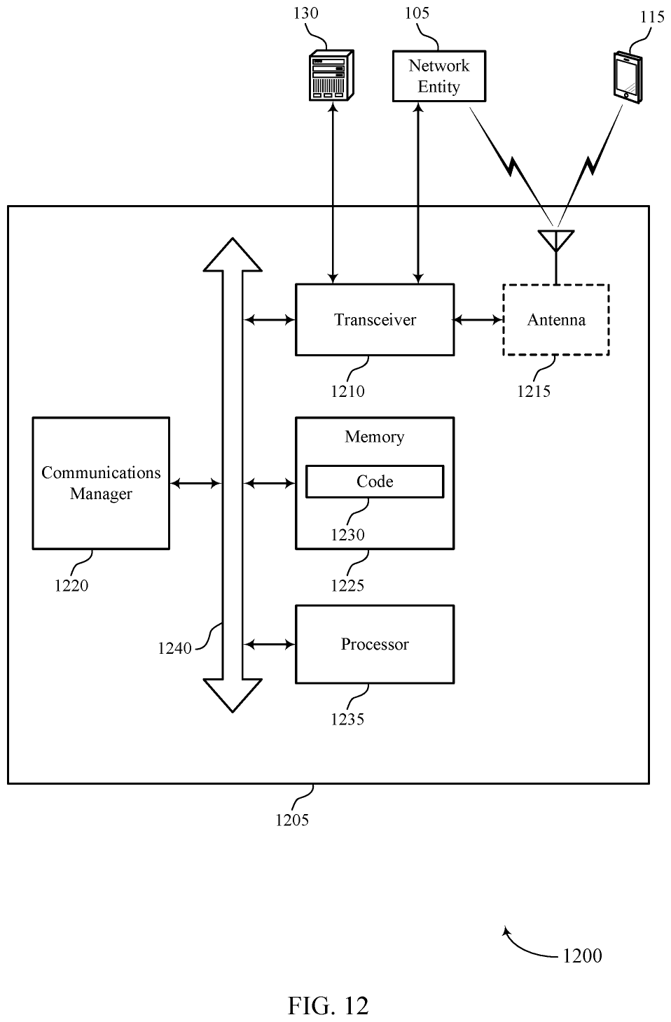

FIG. 12 shows a diagram of a system 1200 including a device 1205 that supports dynamically configuring PRS resources in accordance with one or more aspects of the present disclosure. The device 1205 may be an example of or include the components of a device 905, a device 1005, or a network entity 105, as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both, as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting dynamically configuring PRS resources). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at the device 1205 in accordance with examples disclosed herein. For example, the communications manager 1220 may be configured as or otherwise support a means for outputting a message that indicates a configuration of one or more reference signal resource sets each associated with one or more operating modes of the device 1205. The communications manager 1220 may be configured as or otherwise support a means for obtaining a request for reference signal transmissions via a reference signal resource set of the one or more reference signal resource sets, the reference signal resource set associated with a current operating mode of the device 1205. The communications manager 1220 may be configured as or otherwise support a means for outputting the requested reference signal transmissions via the reference signal resource set in accordance with the configuration.

By including or configuring the communications manager 1220 in accordance with examples described herein, the device 1205 may support techniques for improved on-demand PRS transmission procedures between a UE and the device 1205. More specifically, the described techniques may enable the device 1205 to configure different on-demand PRS resource sets for different operating modes of the device 1205. For example, if the device 1205 enters a power saving mode (e.g., sleep mode), the network entity may configure the UE with on-demand PRS resource sets that include fewer PRS resources or that span fewer time slots. As a result, the device 1205 may attain greater power savings without adversely impacting the accuracy or reliability of PRS measurement procedures at the UE.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. For example, the communications manager 1220 may be configured to receive or transmit messages or other signaling described herein via the transceiver 1210. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of dynamically configuring PRS resources, as described herein, or the processor 1235 and the memory 1225 may be otherwise configured to perform or support such operations.

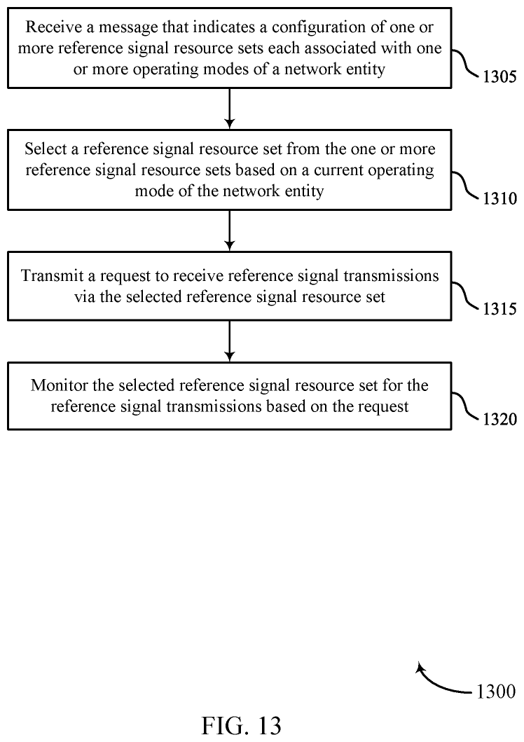

FIG. 13 shows a flowchart illustrating a method 1300 that supports dynamically configuring PRS resources in accordance with one or more aspects of the present disclosure. The operations of the method 1300 may be implemented by a UE or components of a UE, as described herein. For example, the operations of the method 1300 may be performed by a UE 115, as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a message that indicates a configuration of one or more reference signal resource sets each associated with one or more operating modes of a network entity. The operations of 1305 may be performed in accordance with examples disclosed herein. In some examples, the operations of 1305 may be performed by a configuration receiving component 725, as described with reference to FIG. 7. Additionally or alternatively, means for performing the operations of 1305 may, but not necessarily, include, for example, an antenna 825, a transceiver 815, a communications manager 820, memory 830 (including code 835), a processor 840, a bus 845, or any combination thereof.

At 1310, the method may include selecting a reference signal resource set from the one or more reference signal resource sets based on a current operating mode of the network entity. The operations of 1310 may be performed in accordance with examples disclosed herein. In some examples, the operations of 1310 may be performed by an PRS resource selecting component 730, as described with reference to FIG. 7. Additionally or alternatively, means for performing the operations of 1310 may, but not necessarily, include, for example, an antenna 825, a transceiver 815, a communications manager 820, memory 830 (including code 835), a processor 840, a bus 845, or any combination thereof.

At 1315, the method may include transmitting a request to receive reference signal transmissions via the selected reference signal resource set. The operations of 1315 may be performed in accordance with examples disclosed herein. In some examples, the operations of 1315 may be performed by a request transmitting component 735, as described with reference to FIG. 7. Additionally or alternatively, means for performing the operations of 1315 may, but not necessarily, include, for example, an antenna 825, a transceiver 815, a communications manager 820, memory 830 (including code 835), a processor 840, a bus 845, or any combination thereof.

At 1320, the method may include monitoring the selected reference signal resource set for the reference signal transmissions based on the request. The operations of 1320 may be performed in accordance with examples disclosed herein. In some examples, the operations of 1320 may be performed by an PRS resource monitoring component 740, as described with reference to FIG. 7. Additionally or alternatively, means for performing the operations of 1320 may, but not necessarily, include, for example, an antenna 825, a transceiver 815, a communications manager 820, memory 830 (including code 835), a processor 840, a bus 845, or any combination thereof.

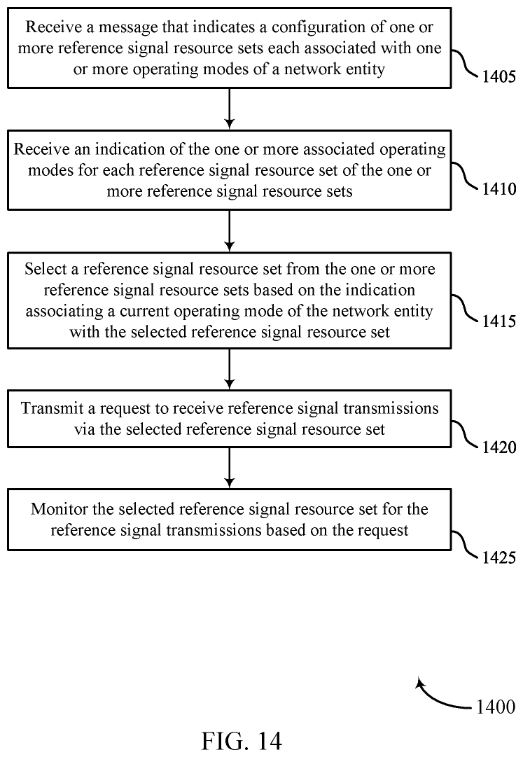

FIG. 14 shows a flowchart illustrating a method 1400 that supports dynamically configuring PRS resources in accordance with one or more aspects of the present disclosure. The operations of the method 1400 may be implemented by a UE or components of a UE, as described herein. For example, the operations of the method 1400 may be performed by a UE 115, as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a message that indicates a configuration of one or more reference signal resource sets each associated with one or more operating modes of a network entity. The operations of 1405 may be performed in accordance with examples disclosed herein. In some examples, the operations of 1405 may be performed by a configuration receiving component 725, as described with reference to FIG. 7. Additionally or alternatively, means for performing the operations of 1405 may, but not necessarily, include, for example, an antenna 825, a transceiver 815, a communications manager 820, memory 830 (including code 835), a processor 840, a bus 845, or any combination thereof.

At 1410, the method may include receiving an indication of the one or more associated operating modes for each reference signal resource set of the one or more reference signal resource sets. The operations of 1410 may be performed in accordance with examples disclosed herein. In some examples, the operations of 1410 may be performed by an indication receiving component 745, as described with reference to FIG. 7. Additionally or alternatively, means for performing the operations of 1410 may, but not necessarily, include, for example, an antenna 825, a transceiver 815, a communications manager 820, memory 830 (including code 835), a processor 840, a bus 845, or any combination thereof.

At 1415, the method may include selecting a reference signal resource set from the one or more reference signal resource sets based on the indication associating a current operating mode of the network entity with the selected reference signal resource set. The operations of 1415 may be performed in accordance with examples disclosed herein. In some examples, the operations of 1415 may be performed by an PRS resource selecting component 730, as described with reference to FIG. 7. Additionally or alternatively, means for performing the operations of 1415 may, but not necessarily, include, for example, an antenna 825, a transceiver 815, a communications manager 820, memory 830 (including code 835), a processor 840, a bus 845, or any combination thereof.

At 1420, the method may include transmitting a request to receive reference signal transmissions via the selected reference signal resource set. The operations of 1420 may be performed in accordance with examples disclosed herein. In some examples, the operations of 1420 may be performed by a request transmitting component 735, as described with reference to FIG. 7. Additionally or alternatively, means for performing the operations of 1420 may, but not necessarily, include, for example, an antenna 825, a transceiver 815, a communications manager 820, memory 830 (including code 835), a processor 840, a bus 845, or any combination thereof.

At 1425, the method may include monitoring the selected reference signal resource set for the reference signal transmissions based on the request. The operations of 1425 may be performed in accordance with examples disclosed herein. In some examples, the operations of 1425 may be performed by an PRS resource monitoring component 740, as described with reference to FIG. 7. Additionally or alternatively, means for performing the operations of 1425 may, but not necessarily, include, for example, an antenna 825, a transceiver 815, a communications manager 820, memory 830 (including code 835), a processor 840, a bus 845, or any combination thereof.

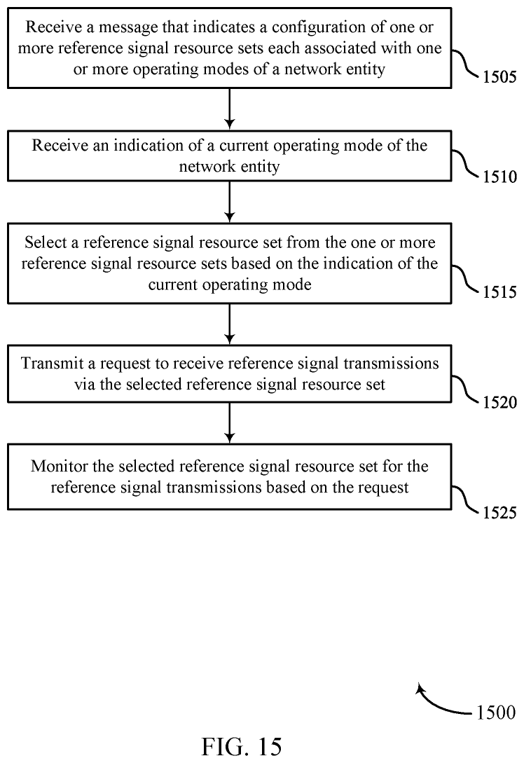

FIG. 15 shows a flowchart illustrating a method 1500 that supports dynamically configuring PRS resources in accordance with one or more aspects of the present disclosure. The operations of the method 1500 may be implemented by a UE or components of a UE, as described herein. For example, the operations of the method 1500 may be performed by a UE 115, as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a message that indicates a configuration of one or more reference signal resource sets each associated with one or more operating modes of a network entity. The operations of 1505 may be performed in accordance with examples disclosed herein. In some examples, the operations of 1505 may be performed by a configuration receiving component 725, as described with reference to FIG. 7. Additionally or alternatively, means for performing the operations of 1505 may, but not necessarily, include, for example, an antenna 825, a transceiver 815, a communications manager 820, memory 830 (including code 835), a processor 840, a bus 845, or any combination thereof.

At 1510, the method may include receiving an indication of a current operating mode of the network entity. The operations of 1510 may be performed in accordance with examples disclosed herein. In some examples, the operations of 1510 may be performed by an indication receiving component 745, as described with reference to FIG. 7. Additionally or alternatively, means for performing the operations of 1510 may, but not necessarily, include, for example, an antenna 825, a transceiver 815, a communications manager 820, memory 830 (including code 835), a processor 840, a bus 845, or any combination thereof.

At 1515, the method may include selecting a reference signal resource set from the one or more reference signal resource sets based on the current operating mode of the network entity. The operations of 1515 may be performed in accordance with examples disclosed herein. In some examples, the operations of 1515 may be performed by an PRS resource selecting component 730, as described with reference to FIG. 7. Additionally or alternatively, means for performing the operations of 1515 may, but not necessarily, include, for example, an antenna 825, a transceiver 815, a communications manager 820, memory 830 (including code 835), a processor 840, a bus 845, or any combination thereof.

At 1520, the method may include transmitting a request to receive reference signal transmissions via the selected reference signal resource set. The operations of 1520 may be performed in accordance with examples disclosed herein. In some examples, the operations of 1520 may be performed by a request transmitting component 735, as described with reference to FIG. 7. Additionally or alternatively, means for performing the operations of 1520 may, but not necessarily, include, for example, an antenna 825, a transceiver 815, a communications manager 820, memory 830 (including code 835), a processor 840, a bus 845, or any combination thereof.

At 1525, the method may include monitoring the selected reference signal resource set for the reference signal transmissions based on the request. The operations of 1525 may be performed in accordance with examples disclosed herein. In some examples, the operations of 1525 may be performed by an PRS resource monitoring component 740, as described with reference to FIG. 7. Additionally or alternatively, means for performing the operations of 1525 may, but not necessarily, include, for example, an antenna 825, a transceiver 815, a communications manager 820, memory 830 (including code 835), a processor 840, a bus 845, or any combination thereof.

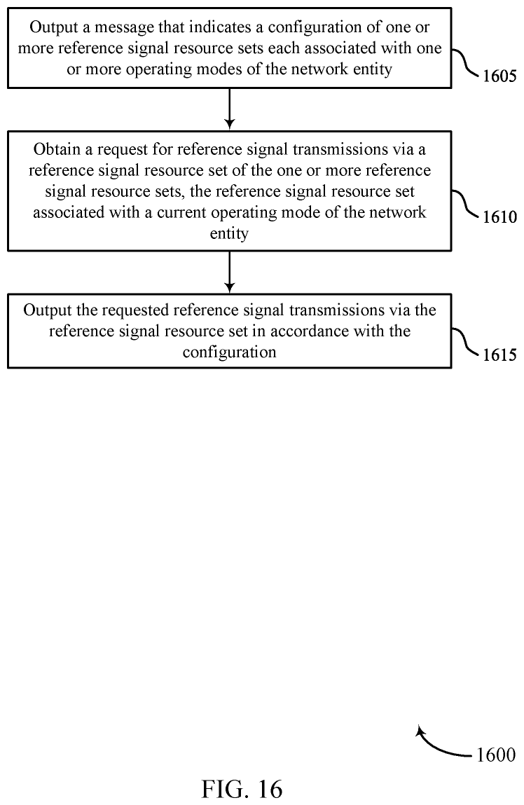

FIG. 16 shows a flowchart illustrating a method 1600 that supports dynamically configuring PRS resources in accordance with one or more aspects of the present disclosure. The operations of the method 1600 may be implemented by a network entity or components of a network entity, as described herein. For example, the operations of the method 1600 may be performed by a network entity 105, as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a message that indicates a configuration of one or more reference signal resource sets each associated with one or more operating modes of the network entity. In some examples, the operations of 1605 may be performed by a message outputting component 1125, as described with reference to FIG. 11. Additionally or alternatively, means for performing the operations of 1605 may, but not necessarily, include, for example, an antenna 1215, a transceiver 1210, a communications manager 1220, memory 1225 (including code 1230), a processor 1235, a bus 1240, or any combination thereof.

At 1610, the method may include obtaining a request for reference signal transmissions via a reference signal resource set of the one or more reference signal resource sets, the reference signal resource set associated with a current operating mode of the network entity. In some examples, the operations of 1610 may be performed by a request obtaining component 1130, as described with reference to FIG. 11. Additionally or alternatively, means for performing the operations of 1610 may, but not necessarily, include, for example, an antenna 1215, a transceiver 1210, a communications manager 1220, memory 1225 (including code 1230), a processor 1235, a bus 1240, or any combination thereof.

At 1615, the method may include outputting the requested reference signal transmissions via the reference signal resource set in accordance with the configuration. In some examples, the operations of 1615 may be performed by a PRS outputting component 1135, as described with reference to FIG. 11. Additionally or alternatively, means for performing the operations of 1615 may, but not necessarily, include, for example, an antenna 1215, a transceiver 1210, a communications manager 1220, memory 1225 (including code 1230), a processor 1235, a bus 1240, or any combination thereof.

The following provides an overview of aspects of the present disclosure:

Aspect 1: A method for wireless communication at a UE, comprising: receiving a message that indicates a configuration of one or more reference signal resource sets each associated with one or more operating modes of a network entity; selecting a reference signal resource set from the one or more reference signal resource sets based at least in part on a current operating mode of the network entity; transmitting a request to receive reference signal transmissions via the selected reference signal resource set; and monitoring the selected reference signal resource set for the reference signal transmissions based at least in part on the request.

Aspect 2: The method of aspect 1, further comprising: receiving an indication of the one or more associated operating modes for each reference signal resource set of the one or more reference signal resource sets, wherein selecting the reference signal resource set is based at least in part on the indication associating the current operating mode with the selected reference signal resource set.

Aspect 3: The method of any of aspects 1 through 2, wherein the selected reference signal resource set is available for selection by the UE when the one or more operating modes associated with the selected reference signal resource set comprise the current operating mode of the network entity; and the selected reference signal resource set is unavailable for selection by the UE when the one or more operating modes associated with the selected reference signal resource set do not comprise the current operating mode of the network entity.

Aspect 4: The method of any of aspects 1 through 3, further comprising: receiving at least one of the reference signal transmissions via the selected reference signal resource set based at least in part on the monitoring, wherein the reference signal transmissions comprise on-demand positioning reference signal transmissions.

Aspect 5: The method of any of aspects 1 through 4, further comprising: receiving an indication of the current operating mode of the network entity, wherein selecting the reference signal resource set is based at least in part on the indication of the current operating mode.

Aspect 6: The method of any of aspects 1 through 5, further comprising: receiving an indication of a time period in which the reference signal resource set is available for selection by the UE, wherein selecting the reference signal resource is based at least in part on the reference signal transmissions being within the time period.

Aspect 7: The method of aspect 6, further comprising: initiating a timer based at least in part on receiving the indication, wherein a duration of the timer corresponds to the time period in which the reference signal resource set is available for selection by the UE, and wherein the reference signal resource set is unavailable for selection by the UE after expiration of the timer.

Aspect 8: The method of any of aspects 6 through 7, wherein a duration of the time period is based at least in part on the current operating mode of the network entity.

Aspect 9: The method of any of aspects 1 through 8, wherein the current operating mode of the network entity comprises a power saving mode of the network entity, a traffic level of the network entity, a transmission power of the network entity, a quantity of transmit antennas used by the network entity, a quantity of UEs served by the network entity, or any combination thereof.

Aspect 10: The method of any of aspects 1 through 9, wherein the message indicates one or more of a repetition factor, a time gap, a periodicity, or a muting pattern for each reference signal resource set of the one or more reference signal resource sets.

Aspect 11: A method for wireless communication at a network entity, comprising: outputting a message that indicates a configuration of one or more reference signal resource sets each associated with one or more operating modes of the network entity; obtaining a request for reference signal transmissions via a reference signal resource set of the one or more reference signal resource sets, the reference signal resource set associated with a current operating mode of the network entity; and outputting the requested reference signal transmissions via the reference signal resource set in accordance with the configuration.

Aspect 12: The method of aspect 11, further comprising: outputting an indication of the one or more associated operating modes for each reference signal resource set of the one or more reference signal resource sets, wherein obtaining the request is based at least in part on the indication associating the current operating mode with the reference signal resource set.

Aspect 13: The method of any of aspects 11 through 12, wherein the reference signal resource set is available for reference signal transmissions when the one or more operating modes associated with the reference signal resource set comprise the current operating mode of the network entity; and the reference signal resource set is unavailable for reference signal transmissions when the one or more operating modes associated with the reference signal resource set do not comprise the current operating mode of the network entity.

Aspect 14: The method of any of aspects 11 through 13, further comprising: outputting an indication of the current operating mode of the network entity, wherein obtaining the request is based at least in part on the indication of the current operating mode.

Aspect 15: The method of any of aspects 11 through 14, further comprising: outputting an indication of a time period in which the reference signal resource set is available for reference signal transmissions, wherein obtaining the request for reference signal transmissions via the reference signal resource set is based at least in part on the reference signal transmissions being within the time period.

Aspect 16: The method of aspect 15, wherein the time period in which the reference signal resource set is available corresponds to a duration of a timer, and the reference signal resource set is unavailable for reference signal transmissions after expiration of the timer.

Aspect 17: An apparatus for wireless communication comprising memory, a transceiver, and at least one processor of a UE, the at least one processor coupled with the memory and the transceiver, and the at least one processor configured to cause the apparatus to perform a method of any of aspects 1 through 10.

Aspect 18: An apparatus for wireless communication, comprising at least one means for performing a method of any of aspects 1 through 10.

Aspect 19: A non-transitory computer-readable medium storing code for wireless communication at a UE, the code comprising instructions executable by a processor to perform a method of any of aspects 1 through 10.

Aspect 20: An apparatus for wireless communication comprising memory, a transceiver, and at least one processor of a network entity, the at least one processor coupled with the memory and the transceiver, and the at least one processor configured to cause the apparatus to perform a method of any of aspects 11 through 16.

Aspect 21: An apparatus for wireless communication, comprising at least one means for performing a method of any of aspects 11 through 16.

Aspect 22: A non-transitory computer-readable medium storing code for wireless communication at a network entity, the code comprising instructions executable by a processor to perform a method of any of aspects 11 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a message that indicates a configuration of one or more reference signal resource sets each associated with one or more operating modes of a network entity;
selecting a reference signal resource set from the one or more reference signal resource sets based at least in part on a current operating mode of the network entity;
transmitting a request to receive reference signal transmissions via the selected reference signal resource set; and
monitoring the selected reference signal resource set for the reference signal transmissions based at least in part on the request.

2. The method of claim 1, further comprising:
receiving an indication of the one or more associated operating modes for each reference signal resource set of the one or more reference signal resource sets, wherein selecting the reference signal resource set is based at least in part on the indication associating the current operating mode with the selected reference signal resource set.

3. The method of claim 1, wherein:
the selected reference signal resource set is available for selection by the UE when the one or more operating modes associated with the selected reference signal resource set comprise the current operating mode of the network entity; and
the selected reference signal resource set is unavailable for selection by the UE when the one or more operating modes associated with the selected reference signal resource set do not comprise the current operating mode of the network entity.

4. The method of claim 1, further comprising:
receiving at least one of the reference signal transmissions via the selected reference signal resource set based at least in part on the monitoring, wherein the reference signal transmissions comprise on-demand positioning reference signal transmissions.

5. The method of claim 1, further comprising:
receiving an indication of the current operating mode of the network entity, wherein selecting the reference signal resource set is based at least in part on the indication of the current operating mode.

6. The method of claim 1, further comprising:
receiving an indication of a time period in which the reference signal resource set is available for selection by the UE, wherein selecting the reference signal resource is based at least in part on the reference signal transmissions being within the time period.

7. The method of claim 6, further comprising:
initiating a timer based at least in part on receiving the indication, wherein a duration of the timer corresponds to the time period in which the reference signal resource set is available for selection by the UE, and wherein the reference signal resource set is unavailable for selection by the UE after expiration of the timer.

8. The method of claim 6, wherein a duration of the time period is based at least in part on the current operating mode of the network entity.

9. The method of claim 1, wherein the current operating mode of the network entity comprises a power saving mode of the network entity, a traffic level of the network entity, a transmission power of the network entity, a quantity of transmit antennas used by the network entity, a quantity of UEs served by the network entity, or any combination thereof.

10. The method of claim 1, wherein the message indicates one or more of a repetition factor, a time gap, a periodicity, or a muting pattern for each reference signal resource set of the one or more reference signal resource sets.

11. A method for wireless communication at a network entity, comprising:
outputting a message that indicates a configuration of one or more reference signal resource sets each associated with one or more operating modes of the network entity;
obtaining a request for reference signal transmissions via a reference signal resource set of the one or more reference signal resource sets, the reference signal resource set associated with a current operating mode of the network entity; and
outputting the requested reference signal transmissions via the reference signal resource set in accordance with the configuration.

12. The method of claim 11, further comprising:
outputting an indication of the one or more associated operating modes for each reference signal resource set of the one or more reference signal resource sets, wherein obtaining the request is based at least in part on the indication associating the current operating mode with the reference signal resource set.

13. The method of claim 11, wherein:
the reference signal resource set is available for reference signal transmissions when the one or more operating modes associated with the reference signal resource set comprise the current operating mode of the network entity; and
the reference signal resource set is unavailable for reference signal transmissions when the one or more operating modes associated with the reference signal resource set do not comprise the current operating mode of the network entity.

14. The method of claim 11, further comprising:
outputting an indication of the current operating mode of the network entity, wherein obtaining the request is based at least in part on the indication of the current operating mode.

15. The method of claim 11, further comprising:
outputting an indication of a time period in which the reference signal resource set is available for reference signal transmissions, wherein obtaining the request for reference signal transmissions via the reference signal resource set is based at least in part on the reference signal transmissions being within the time period.

16. The method of claim 15, wherein:
the time period in which the reference signal resource set is available corresponds to a duration of a timer, and
the reference signal resource set is unavailable for reference signal transmissions after expiration of the timer.

17. An apparatus for wireless communication, comprising:
memory;
a transceiver; and
at least one processor of a user equipment (UE), the at least one processor coupled with the memory and the transceiver, and the at least one processor configured to cause the apparatus to:
receive, via the transceiver, a message that indicates a configuration of one or more reference signal resource sets each associated with one or more operating modes of a network entity;
select a reference signal resource set from the one or more reference signal resource sets based at least in part on a current operating mode of the network entity;
transmit, via the transceiver, a request to receive reference signal transmissions via the selected reference signal resource set; and
monitor the selected reference signal resource set for the reference signal transmissions based at least in part on the request.

18. The apparatus of claim 17, the at least one processor further configured to cause the apparatus to:
receive, via the transceiver, an indication of the one or more associated operating modes for each reference signal resource set of the one or more reference signal resource sets, wherein selecting the reference signal resource set is based at least in part on the indication associating the current operating mode with the selected reference signal resource set.

19. The apparatus of claim 17, the at least one processor further configured to cause the apparatus to:
receive, via the transceiver, an indication of the current operating mode of the network entity, wherein selecting the reference signal resource set is based at least in part on the indication of the current operating mode.

20. The apparatus of claim 17, the at least one processor further configured to cause the apparatus to:
receive, via the transceiver, an indication of a time period in which the reference signal resource set is available for selection by the UE, wherein the at least one processor is configured to cause the apparatus to select the reference signal resource based at least in part on the reference signal transmissions being within the time period.
